(19) United States
(12) Patent Application Publication
(10) Pub. No.: US 2014/0371981 A1
(43) Pub. Date: Dec. 18, 2014

(54) METHOD AND APPARATUS FOR OPERATING A VEHICLE

(71) Applicants: Stefan NORDBRUCH, Kornwestheim (DE); Oliver PINK, Stuttgart (DE)

(72) Inventors: Stefan NORDBRUCH, Kornwestheim (DE); Oliver PINK, Stuttgart (DE)

(73) Assignee: ROBERT BOSCH GMBH, Stuttgart (DE)

(21) Appl. No.: 14/300,982

(22) Filed: Jun. 10, 2014

(30) Foreign Application Priority Data
Jun. 12, 2013 (DE) 10 2013 210 941.5

(51) Int. Cl. B60W 40/09; G07C 5/08

(52) U.S. Cl. CPC B60W 40/09; G07C 5/0841; B60W 2530/14; B60W 2540/30; B60W 2550/402
USPC 701/36

(57) ABSTRACT

In a method for operating a vehicle, a vehicle guidance activity of a driver of the vehicle is monitored so that, based on the monitored vehicle guidance activity, driving parameters describing a driving style of the driver are generated and provided to a driver assistance system of the vehicle so that the driver's driving style is at least partly reproduced in the context of control of the vehicle by the driver assistance system.

### BACKGROUND OF THE INVENTION

1. Field of the Invention

The present invention relates to a method, a computer program and an apparatus for operating a vehicle.

2. Description of the Related Art

Partly and highly automated systems, and automatically or autonomously driving systems, of a vehicle generally exhibit a specific driving behavior in specific driving situations (for example, in the passing operation: defensive, sporty, etc.). This behavior is usually programmed in as standard.

It can happen, however, that in these driving situations a driver of the vehicle wishes to drive differently as compared with the aforementioned systems. A driving behavior of the driver can thus be different from a driving behavior of the systems.

Published European patent application document EP 2 293 255 A1 discloses a method for controlling a motor vehicle. Here a driver behavior is measured and analyzed in order to disengage systems, or parts of systems, of the vehicle. The driver is therefore evaluated. If the evaluation of him or her is sufficiently good, the systems are disengaged. If the evaluation is not sufficiently good, no disengagement occurs.

The known systems are disadvantageous in particular in that no adaptation to a driving style of the driver occurs. The result of this can be in particular that the driver switches off or deactivates such systems, since he or she finds them inconvenient and not familiar, i.e. foreign. The result of this in turn can be that vehicle safety can thereby be negatively affected in specific critical traffic situations, since the systems can no longer intervene in a vehicle guidance activity, or can do so to only a limited extent.

### BRIEF SUMMARY OF THE INVENTION

According to an aspect of the present invention, a method for operating a vehicle is furnished, in which a vehicle guidance activity of a driver of the vehicle is monitored so that, based on the monitored vehicle guidance activity, driving parameters describing a driving style of the driver are created, which parameters are furnished to a driver assistance system of the vehicle so that the driver's driving style is at least partly reproduced in the context of control of the vehicle by the driver assistance system.

According to a further aspect, an apparatus for operating a vehicle is furnished, encompassing a monitoring device for monitoring a vehicle guidance activity of a driver of the vehicle, a parameter creation device for creating driving parameters describing a driving style of the driver based on the monitored vehicle guidance activity, and a furnishing device for furnishing the driving parameters to a driver assistance system.

According to yet another aspect, a system for operating a vehicle is furnished, encompassing the apparatus for operating a vehicle and a driver assistance system that is embodied to control the vehicle, based on the driving parameters furnished, in a manner at least partly reproducing the driver's driving style.

According to another aspect, a computer program is furnished which encompasses program code for carrying out the method for operating a vehicle when the computer program is executed on a computer, in particular in a driver assistance system, in particular in a controller of a driver assistance system.

The invention therefore encompasses in particular the idea of detecting a driving style of the driver by monitoring his or her vehicle guidance activity, and correspondingly emulating or mimicking or imitating it. This therefore means in particular that thanks to the correspondingly created driving parameters, the driver assistance system is capable of at least partly, preferably entirely reproducing the driver's driving style. When the driver assistance system is controlling the vehicle in at least partly automated or partly autonomous fashion, in particular entirely automatically or entirely autonomously, the driver will recognize that type of control as his or her own. This advantageously brings about increased acceptance by the driver with regard to control by the driver assistance system. He or she will therefore generally not deactivate the driver assistance system. The advantageous result of this is that vehicle safety in specific critical situations is not diminished or negatively affected because the driver assistance has been switched off or deactivated, since the driver assistance system can intervene in a vehicle guidance activity, in particular, for example, in order to avoid a collision or, for example, in order to decrease the severity of an accident.

When the term “automated” is used hereinafter, the term “autonomous” can instead or additionally be used or concurrently read, and vice versa.

“Driver assistance systems” for purposes of the present invention refers in particular to electronic devices that can assist a driver in specific driving situations. Driver assistance systems of this kind intervene in a drive system and/or a controller and/or signaling devices of the vehicle, in particular in partly automated or automated fashion, and/or use a human/machine interface to warn a driver shortly before or during a critical traffic situation. The driver assistance systems can for this purpose preferably be in effective connection with actuators and/or positioners of the vehicle.

For purposes of the present invention, driver assistance systems can be embodied in particular to control the vehicle automatically, with no need for the driver to intervene in a vehicle guidance activity. In this case the vehicle is controlled by way of the driver assistance system. The driver assistance system can be embodied in particular to control sub-aspects of the vehicle guidance activity. Such sub-aspects can be, for example, a longitudinal vehicle guidance activity and/or a transverse vehicle guidance activity.

“Driving parameters” for purposes of the present invention describe in particular a driving style of the driver. This means, for example, that the driving parameters describe the distance that the driver as a rule maintains from a preceding vehicle. The driving parameters can describe, for example, the deceleration and/or acceleration with which the driver brakes or accelerates the vehicle. The driving parameters can describe, for example, the cornering speed at which the driver enters and/or drives through a curve having a specific curve radius. The driving parameters can in particular describe how strongly the driver actuates a brake pedal, a clutch pedal, and/or an accelerator pedal. The driving parameters can in particular describe the points in time, with reference to an engine rotation speed, at which the driver as a rule performs a gear change.

Further driving parameters that describe a driving style of the driver can, for example, describe or parameterize the following situations:

A speed in general (not only cornering speed but, for example, a typical speed on expressways, for example 100 km/h to 150 km/h).

The speed difference with respect to the desired speed that the driver accepts before changing lanes (does the driver drive slowly behind a truck, or prefer to pull out immediately), i.e., the driving parameter here would be, for example, the speed difference and/or whether the driver remains behind the truck or pulls out.

A lateral spacing: how closely, i.e. at what distance, the driver drives laterally past objects, in particular further vehicles. The driving parameter here would be in particular the lateral spacing.

Speed through narrow areas: how fast the driver drives through a narrow area having a given width (if the automatic system is faster than the driver him- or herself, the driver usually finds this highly unpleasant). The driving parameter here would be in particular the speed at which the driver drives his or her vehicle through the narrow area.

Speed as a function of a current traffic density. The driving parameter here would be in particular that speed.

The fact that the controller, based on the driving parameters, at least partly, in particular entirely reproduces the driver's driving style therefore means in particular that at least sub-aspects of the driver's driving style are implemented by way of the driver assistance system when controlling the vehicle. In the extreme case, the driver's driving style is entirely reproduced. This therefore means in particular that, considered from outside, there is no difference between control of the vehicle on the part of the driver and control on the part of the driver assistance system.

According to an embodiment, provision can be made that a driving situation existing during monitoring is classified and the driving parameters are associated with the classified driving situation, so that when a driving situation existing in the context of control of the vehicle by the driver assistance system corresponds to the classified driving situation, the driver assistance system controls the vehicle based on the driving parameters associated with the classified driving situation.

This therefore means in particular that the specific existing driving situation in which the driver exhibited this or that behavior is sensed. When a similar or even identical driving situation exists in the context of control of the vehicle by the driver assistance system, the vehicle can then be controlled in accordance with the driving situation that presented itself during monitoring. This thereby makes it possible in particular, to ensure advantageously that in a specific driving situation the driver assistance system controls the vehicle at least partly, in particularly entirely as the driver him- or herself would.

What takes place is therefore in particular a sensing of an existing driving situation with subsequent classification, in particular during monitoring and in particular during control of the vehicle by the driver assistance system.

According to an embodiment, provision can be made that an instantaneous driving situation is sensed. An instantaneous driving situation can be in particular a situation in which a further vehicle is driving in front of the vehicle at a specific speed and distance. The driver assistance system then controls the vehicle in particular based on a driving parameter that is associated with or corresponds to a distance from a preceding vehicle, said driving parameter having been created in a similar driving situation, located earlier in time than the instantaneous driving situation, in which the driver him- or herself was controlling the vehicle. This applies in particular generally analogously for any driving situation. What is ascertained in general in the instantaneous driving situation is therefore how the driver was controlling the vehicle in a similar driving situation earlier in time. This is then at least partly reproduced in the instantaneous driving situation.

According to a further embodiment, provision can be made that the existing driving situation is associated, for classification, with a driving situation class, for example expressway, main road, city, environmental conditions, selected from the following group of driving situation classes: passing maneuver, “bumper to bumper” traffic, driving with an activated adaptive speed control device, cornering, partly automated driving, and automated driving.

For example, when the driver assistance system is controlling the vehicle at least partly automatically, in particular entirely automatically during a passing maneuver, it will then do so in almost exactly the way in which the driver would control the vehicle during the passing maneuver.

The association between driving parameters and the classified driving situation advantageously brings about a considerable simplification. This is because it is as a rule sufficient, in order to control the vehicle by way of the driver assistance system, simply to use the driving parameters that are associated with the classified driving situation. A data outlay, and a considerable memory space requirement associated therewith, can thus advantageously be reduced. A correspondingly required processing time can also advantageously be considerably reduced.

According to a further embodiment, provision can be made that for monitoring, at least one element selected from the following group of elements is measured or sensed: distance from a further vehicle driving in front of the vehicle, distance from a further vehicle driving behind the vehicle, speed of a further vehicle driving in front of the vehicle, speed of a further vehicle driving behind the vehicle, speed profile in terms of time and/or space, acceleration profile in terms of time and/or space, vehicle position, size of a gap between a further vehicle driving in front of the vehicle and one or more other vehicles driving in front of the further vehicle, driver interventions in a vehicle guidance activity, in particular braking, steering, acceleration, steering, behavior of the driver when another vehicle drives into the gap between the driver's vehicle and a further vehicle driving in front of the driver's vehicle, distance from further objects that need not necessarily be a vehicle, for example guardrails, stationary obstacles, distances and/or speeds with respect to vehicles in another lane or in other lanes.

This therefore means in particular that, for example, a distance from a further vehicle driving in front of the vehicle is measured. That distance can then be, for example, a driving parameter that can describe a sub-aspect of the driver's driving style.

In general, the aforementioned elements can, for example, each be associated with a driving parameter and/or preferably can create driving parameters, which then can thereby advantageously at least partly, in particularly entirely describe the driver's driving style.

According to another embodiment, provision can be made that during monitoring, a vehicle environment is sensed and vehicle environment data describing the vehicle environment, which are associated with the driving parameters, are created, so that when a vehicle environment existing in the context of control of the vehicle by the driver assistance system at least partly corresponds to the vehicle environment sensed during monitoring, the driver assistance system controls the vehicle based on the driving parameters with the associated vehicle environment data.

This therefore means in particular that the driver's driving style is linked to a specific vehicle environment. For example, the driver will as a rule drive the vehicle differently on a wet road than on a dry road.

When a vehicle environment that corresponds at least partly, in particular entirely to the vehicle environment sensed during monitoring exists in the context of the control of the vehicle by the driver assistance system, the driver assistance system will then advantageously control the vehicle at least partly, in particular entirely as the driver would.

Sensing of the vehicle environment can encompass, for example, sensing of one or more environmental conditions, for example brightness, day/night driving, time of day, tunnel, dazzle. Such environmental conditions can be, for example, a weather condition and a road state. Sensing of the vehicle environment can encompass, for example, sensing of one or more traffic conditions. Such traffic conditions can be, for example, a traffic jam and traffic lights, also called traffic signals.

Analogously to sensing of the vehicle environment, according to a further embodiment provision can be made that a vehicle position and/or a route or travel path of the vehicle to be driven and/or a time, in particular a time of day, and/or a driver state, for example fatigue, are sensed and are associated with and/or create corresponding driving parameters, so that when a situation existing in the context of control of the vehicle by the driver assistance system (for example a situation relating to a vehicle position and/or a route or travel path of the vehicle to be driven and/or a time, in particular a time of day, and/or a driver state, for example fatigue) at least partly, in particular entirely corresponds to the one that also existed during monitoring, the driver assistance system controls the vehicle based on the corresponding driving parameters.

According to a further embodiment, provision can be made that a number of vehicle occupants is sensed and is associated with the driving parameters, so that when a number of vehicle occupants in the context of control of the vehicle by the driver assistance system is equal to the number of vehicle occupants during monitoring, the driver assistance system controls the vehicle based on the driving parameters with the associated number of vehicle occupants.

This therefore means in particular that what is sensed is whether the driver is alone in the vehicle or whether further vehicle occupants, for example children, are also present.

According to another embodiment, provision can be made that the driving parameters are adjusted, prior to control of the vehicle by the driver assistance system, to driving safety parameters describing a safe driving style, so that as a function of the comparison, adjusted driving parameters are created which are furnished to the driver assistance system so that in the context of control of the vehicle by the driver assistance system, the driver's driving style is reproduced only to the extent that it is encompassed by the safe driving style.

This therefore means in particular that, for example, an adjustment to traffic rules or to road traffic legislation is carried out. For example, an adjustment to speed stipulations and/or passing maneuver stipulations is made. The driver assistance system will then control the vehicle only in the context of what is legally permitted. In particular, a restriction to a safe manner of driving, for example minimum distances and/or maximum speeds when cornering, can additionally or alternatively be provided here.

This therefore means in particular that as a result of the adjustment, the driver's driving style is reproduced only to the extent that it is encompassed by the safe driving style.

The safe driving style describes in particular a driving style that complies with legislative provisions and/or characterizes a safe manner of driving.

According to an embodiment, provision can be made that in order to create the driving parameters, an average is calculated over multiple monitored trips. This therefore means in particular that a corresponding vehicle guidance activity is monitored during several trips, corresponding driving parameters then being created here for the individual trips. An average of the driving parameters thereby ascertained or created can then preferably be calculated. For example, provision can be made here that for the average calculation, the ascertained driving parameters are weighted in terms of specific driving situations.

According to an embodiment, provision can be made that the monitoring device encompasses one or more sensors. The sensors can be embodied identically or, in particular, differently. Such sensors can be, for example, the following sensors: driving state sensor, vehicle environment sensor, sensor of a driver assistance system, position sensor, in particular GPS sensor of a navigation system, position sensor of a non-navigation system, radar sensor, acceleration sensor, steering angle sensor, ultrasonic sensor, optical sensor, lidar sensor, video sensor, sensors for vehicle monitoring, for example occupant sensor, alertness sensor.

This therefore means in particular that monitoring of the driver's vehicle guidance activity can be carried out by way of at least one sensor, in particular by way of multiple sensors, of the aforementioned sensors. This therefore means in particular that the driving parameters can be created based on the corresponding measured data of the sensors. For example, by way of an interior camera encompassing a video sensor it is possible to check whether the driver routinely looks over his or her shoulder, for example when intending to change lanes or when turning. This is an indication in particular of anticipatory driving. It is possible, for example, to observe whether the driver tends toward excessive steering actions at high speed, generally also referred to as “swerving.”

In order to provide assurance, advantageously, that the same driver is always being monitored, according to another embodiment provision can be made that a driver identifier is associated with the driving parameters. A driver identifier of this kind can encompass, for example, a biometric feature of the driver. When the driver identifier, for example, the biometric feature, is then sensed during operation of the vehicle, the driving parameters associated with the driver identifier can then be utilized for control of the vehicle on the part of the driver assistance system. A driver identifier can encompass, for example, a chip identifier, for example of an RFID chip. A chip of this kind, in particular an RFID chip, can be incorporated, for example, into a vehicle key.

### BRIEF DESCRIPTION OF THE DRAWINGS

FIG. 1 is a flow chart of a method for operating a vehicle.

FIG. 2 shows an apparatus for operating a vehicle.

FIG. 3 shows a system for operating a vehicle.

FIG. 4 is a flow chart of a further method for operating a vehicle.

### DETAILED DESCRIPTION OF THE INVENTION

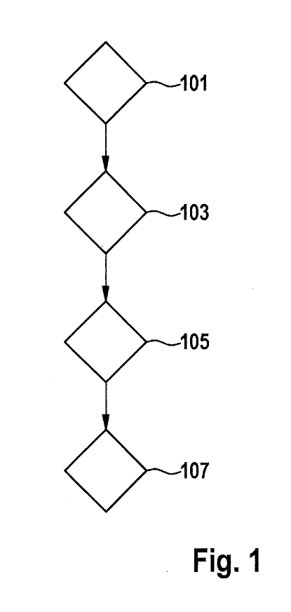

FIG. 1 is a flow chart of a method for operating a vehicle. According to a step 101, a vehicle guidance activity of a driver of the vehicle is monitored. Then in a step 103, based on the monitored vehicle guidance activity, driving parameters that describe a driving style of the driver are created. In a step 105 these driving parameters are furnished to a driver assistance system of the vehicle. In a step 107, the driver's driving style can thus be at least partly, preferably entirely reproduced in the context of control of the vehicle by the driver assistance system.

This advantageously brings about increased acceptance of the driver assistance system on the part of the driver. The latter will then as a rule leave the driver assistance system switched on so that it can then advantageously intervene in specific critical situations and control the vehicle. This can advantageously cause vehicle safety to be increased in such critical driving situations.

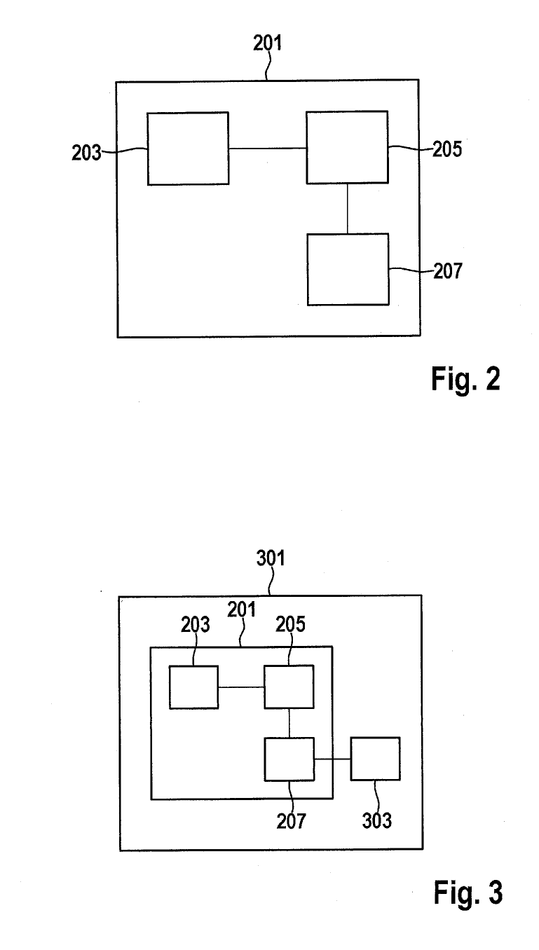

FIG. 2 shows an apparatus 201 for operating a vehicle which is not shown. Apparatus 201 encompasses a monitoring device 203 for monitoring a vehicle guidance activity of a driver of the vehicle. Apparatus 201 furthermore encompasses a parameter creation device 205 for creating, based on the monitored vehicle guidance activity, driving parameters describing a driving style of the driver. Apparatus 201 moreover encompasses a furnishing device 207 for furnishing the driving parameters to a driver assistance system that, however, does not necessarily need to be encompassed by apparatus 201.

In an alternative embodiment (which is not shown), provision can be made that monitoring device 203 encompasses one or more sensors that are embodied to sense a vehicle guidance activity of the driver. Video sensors, radar sensors, ultrasonic sensors, lidar sensors can be provided for this, for example. In general, such sensors can be environmental sensors that can sensorially sense a vehicle environment. The distance maintained by the driver of the vehicle from a preceding vehicle can, for example, advantageously be sensed. Sensors can be, for example, acceleration sensors and/or steering angle sensors.

FIG. 3 shows a system 301 for operating a vehicle (not shown). System 301 encompasses apparatus 201 in accordance with FIG. 2. System 301 further encompasses a driver assistance system 303 that is embodied to control the vehicle, based on the driving parameters furnished, in such a way that the driver's driving style is at least partly, preferably entirely reproduced. This therefore means in particular that driver assistance system 303 controls the vehicle at least approximately as the driver would in the specific existing driving situation.

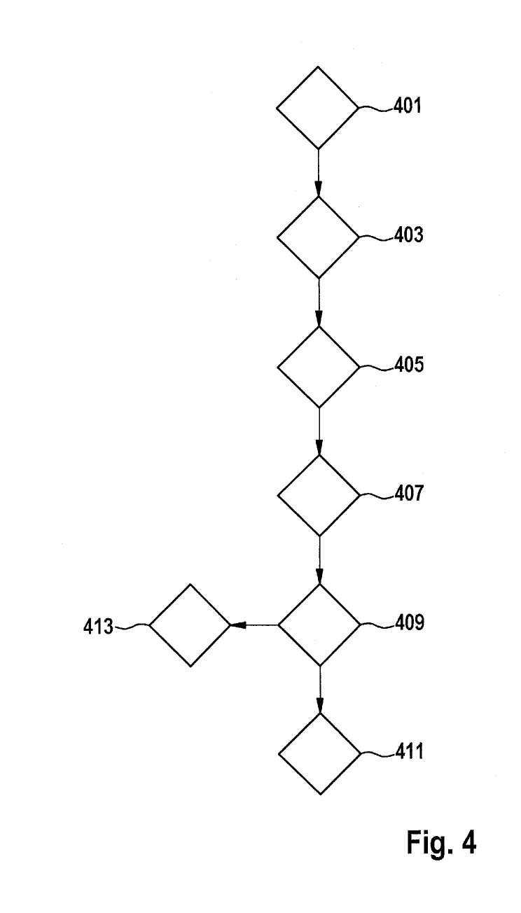

FIG. 4 is a flow chart of a further method for operating a vehicle. According to a step 401, an instantaneous or existing driving situation is sensed and classified. In the exemplifying embodiment that now follows, it is assumed for the sake of clarity that the existing driving situation is a passing maneuver. The statements that follow are not intended, however, to be limited to a passing maneuver. Any other driving situations can be provided and are then also correspondingly classified.

According to a step 403, a vehicle guidance activity of a driver of the vehicle is then monitored during the passing maneuver. Provision can be made, for example, to monitor a speed profile and/or acceleration profile in terms of time and/or space. In particular, relative distances between the vehicle and the vehicle or vehicles to be passed can be measured.

In a step 405, driving parameters are then created in accordance with the monitored vehicle guidance activity, i.e. in particular based on the aforesaid exemplifying measured values. These driving parameters are then associated with the classified driving situation, i.e. in this case with the passing maneuver, and furnished to a driver assistance system of the vehicle.

In a step 407, a further driving situation subsequent in time to the above driving situation is sensed and classified before the driver assistance controls the vehicle, i.e. intends to automatically carry out an intervention in a vehicle guidance activity. A classification of this further driving situation furthermore takes place in step 407.

A step 409 checks whether this further driving situation is a passing maneuver. If so, in a step 411 the driver assistance system will control the vehicle based on the driving parameters that are associated with the passing maneuver. The advantageous result of this is that the driver assistance system can control the vehicle during the passing maneuver as the driver him- or herself would. If it is ascertained in step 409 that this further driving situation is not a passing maneuver, then according to a step 413 the driver assistance will control the vehicle based on standard driving parameters or standard control data that can be, for example, permanently programmed into or stored in the driver assistance system. This ensures in particular that the driver assistance system can always control the vehicle regardless of whether driving parameters that describe a driving style of the driver have already been created.

In an alternative embodiment which is not shown, provision can be made that in step 413, the driving parameters are selected from a set of driving parameters that are associated with the further driving situation and that in particular have already been created analogously to step 405 for the driving situation that then correspondingly existed.

In summary, the invention therefore encompasses in particular the idea of continuously or constantly monitoring a vehicle guidance activity of a driver of a vehicle, i.e. in general terms the driver's driving style, in specific driving situations, and creating therefrom corresponding driving parameters that can in particular describe a generally typical driver behavior, i.e. the driving style. In particular, an average over multiple trips can be calculated.

Examples of such driving situations can be a passing maneuver, “bumper to bumper” traffic, driving with an activated adaptive cruise control system, cornering, partly automated driving, or automated driving.

In a passing maneuver, for example, a distance from a preceding vehicle can be measured. A distance from traffic in the direction behind the vehicle in terms of the driving direction can, for example, be measured. In particular, a size of a gap between the vehicle to be passed and a vehicle preceding the vehicle to be passed can be measured. In particular, an acceleration profile in terms of space and/or time, and/or an acceleration profile in terms of space and/or time, of the vehicle can be measured.

In the context of driving with an activated adaptive speed control device and/or of “bumper to bumper” traffic, for example, the distance from a preceding vehicle can be measured. In particular, a behavior of the driver when another vehicle drives into the gap in front of the vehicle and the immediately preceding vehicle can be sensed.

In a context of partly automated driving and/or automated driving, for example, a driver intervention or multiple driver interventions during partly automated or automated driving can be sensed. For example, whether the driver accelerates the vehicle, i.e. actuates the gas pedal, can be sensed. This is generally an indication that the driver assistance system that is controlling the vehicle during partly automated or automated driving is controlling the vehicle too slowly for the driver and/or is establishing too large or too long a distance from a preceding vehicle.

If the driver decelerates the vehicle in a context of partly automated driving and/or automated driving, this is generally an indication that a distance from the immediately preceding vehicle is too short for the driver and/or that the driver assistance system is too fast for the driver, i.e. is establishing too high a speed for the vehicle.

As a result of monitoring, and then corresponding calculation of the driving parameters, the system or the apparatus learns how the driver, for example, controls his or her vehicle in specific driving situations. This can then be advantageously imitated or emulated.

An expansion or supplement or alternative to averaging could be, for example, that further correlations with the driver's behavior are taken into account for corresponding calculations. These could be, for example, the following correlations: position/route, ambient conditions (e.g. weather, road state), traffic conditions (e.g. traffic jam, traffic signals), time of day, driver state (e.g. fatigue), number of persons in the car (e.g. alone, with several, with children).

With a knowledge of this driver behavior, control of the vehicle on the part of a driver assistance system can advantageously be adapted to the individual driver by learning over time.

The adaptation advantageously takes into account an adjustment to traffic rules (e.g. speed stipulations, passing maneuver stipulations) and/or a limitation to a safe manner of driving (e.g. minimum distances, maximum speeds in curves).

What is claimed is:

1. A method for operating a vehicle, comprising:
monitoring, by a monitoring device, a vehicle guidance activity of a driver of the vehicle;
generating, by a control unit including a processor, driving parameters based on the monitored vehicle guidance activity, wherein the driving parameters describe a driving style of the driver;
providing the driving parameters to a driver assistance system of the vehicle; and
at least partly reproducing, by the driver assistance system, the driver's driving style in the context of control of the vehicle by the driver assistance system.

2. The method as recited in claim 1, wherein:
a driving situation existing during the monitoring is classified; and
the driving parameters are associated with the classified driving situation, so that when a driving situation existing in the context of control of the vehicle by the driver assistance system corresponds to the classified driving situation, the driver assistance system controls the vehicle based on the driving parameters associated with the classified driving situation.

3. The method as recited in claim 2, wherein for the classification, the existing driving situation is associated with a driving situation class selected from the following group of driving situation classes: passing maneuver, bumper-to-bumper traffic, driving with an activated adaptive speed control device, cornering, partly automated driving, and automated driving.

4. The method as recited in claim 3, wherein at least one element selected from the following group of elements is measured or sensed for the monitoring: distance from a further vehicle driving in front of the vehicle; distance from a further vehicle driving behind the vehicle; speed profile in terms of at least one of time and space; acceleration profile in terms of at least one of time and space; vehicle position; size of a gap between the further vehicle driving in front of the vehicle and another vehicle driving in front of the further vehicle; a driver intervention in a vehicle guidance activity including at least one of braking, steering, acceleration, and steering; and behavior of the driver when another vehicle drives into the gap between the driver's vehicle and the further vehicle driving in front of the driver's vehicle.

5. The method as recited in claim 3, wherein an environment of the vehicle is monitored during the monitoring to generate vehicle environment data describing the vehicle environment, which vehicle environment data are associated with the driving parameters, so that when a vehicle environment existing in the context of control of the vehicle by the driver assistance system at least partly corresponds to the vehicle environment sensed during the monitoring, the driver assistance system controls the vehicle based on the driving parameters with the associated vehicle environment data.

6. The method as recited in claim 3, wherein a number of vehicle occupants is sensed during the monitoring and associated with the driving parameters, so that when a number of vehicle occupants in the context of control of the vehicle by the driver assistance system is equal to the number of vehicle occupants sensed during the monitoring, the driver assistance system controls the vehicle based on the driving parameters with the associated number of vehicle occupants.

7. The method as recited in claim 3, further comprising:
adjusting the driving parameters, prior to control of the vehicle by the driver assistance system, based on a comparison to predetermined driving safety parameters describing a safe driving style, so that as a function of the comparison, adjusted driving parameters are generated and provided to the driver assistance system so that in the context of control of the vehicle by the driver assistance system, the driver's driving style is reproduced only to the extent that the driver's driving style corresponds to the safe driving style.

8. A system for operating a vehicle, comprising:
a monitoring device for monitoring a vehicle guidance activity of a driver of the vehicle;
a parameter generation device for generating driving parameters describing a driving style of the driver based on the monitored vehicle guidance activity; and
a furnishing device for furnishing the driving parameters to a driver assistance device.

9. The system as recited in claim 8, wherein the driver assistance device is part of the system, and the driver assistance device is configured to control the vehicle based on the furnished driving parameters, in a manner at least partly reproducing the driver's driving style.

10. A non-transitory, computer-readable data storage medium storing a computer program having program codes which, when executed on a computer, performs a method for operating a vehicle, the method comprising:
monitoring, by at least one sensor, a vehicle guidance activity of a driver of the vehicle;
generating, by a control unit including a processor, driving parameters based on the monitored vehicle guidance activity, wherein the driving parameters describe a driving style of the driver;
providing the driving parameters to a driver assistance system of the vehicle; and
at least partly reproducing, by the driver assistance system, the driver's driving style in the context of control of the vehicle by the driver assistance system.
